(19) United States
(12) Patent Application Publication
(10) Pub. No.: US 2024/0278195 A1
(43) Pub. Date: Aug. 22, 2024

(54) MICROPOROUS LAYER

(71) Applicants: TOYOTA JIDOSHA KABUSHIKI KAISHA, Toyota-shi (JP); AISIN KAKO KABUSHIKI KAISHA, Toyota-shi (JP)

(72) Inventors: Hidenari YAMAMOTO, Miyoshi-shi (JP); Masanori AIMU, Toyota-shi (JP); Risako TANII, Toyota-shi (JP); Hajime MAKINO, Tajimi-shi (JP); Yurika SAKAMOTO, Nagoya-shi (JP)

(73) Assignees: TOYOTA JIDOSHA KABUSHIKI KAISHA, Toyota-shi (JP); AISIN KAKO KABUSHIKI KAISHA, Toyota-shi (JP)

(21) Appl. No.: 18/582,233

(22) Filed: Feb. 20, 2024

(30) Foreign Application Priority Data
Feb. 22, 2023 (JP) 2023-026327

(51) Int. Cl. B01D 71/36; B01D 69/14

(52) U.S. Cl. CPC B01D 71/36; B01D 69/1411; B01D 2323/081; B01D 2325/02834; B01D 2325/26

(57) ABSTRACT

In a microporous layer of the present embodiment, a falling angle of an aqueous solution containing 25 wt % of ethanol is less than 30° and a strength determined by SAICAS evaluation is more than 0.068 N.

### CROSS-REFERENCE TO RELATED APPLICATION

This application claims priority to Japanese Patent Application No. 2023-026327 filed on Feb. 22, 2023, incorporated herein by reference in its entirety.

### BACKGROUND

### 1. Technical Field

The present disclosure relates to a microporous layer.

### 2. Description of Related Art

A solid polymer fuel cell includes a membrane electrode assembly (MEA) in which an electrode (catalyst layer) is bonded to both sides of an electrolyte membrane made of a solid polymer electrolyte. In addition, in the solid polymer fuel cell, generally, a gas diffusion layer is arranged outside the catalyst layer. The gas diffusion layer is a layer for supplying a reaction gas and electrons to the catalyst layer, and carbon paper, carbon cloth or the like is used therefor. In addition, a separator having a gas flow path is arranged outside the gas diffusion layer. The solid polymer fuel cell generally has a structure (fuel cell stack) in which a plurality of single cells each including such an MEA, a gas diffusion layer and a separator are laminated. Provision of a microporous layer in the gas diffusion layer in consideration of water management has been proposed in the related art.

For example, WO 2016/076132 proposes a gas diffusion electrode substrate having a carbon sheet and a microporous layer, wherein the carbon sheet is porous, a DBP oil absorption amount of carbon powder contained in the microporous layer is 70 to 155 ml/100 g, the microporous layer has a penetration index (L/W) of 1.10 to 8.00, which is calculated from a basis weight (W) of the microporous layer and a thickness (L) of the microporous layer, and the thickness (L) of the microporous layer is 10 to 100 μm.

### SUMMARY

The present disclosure provides a microporous layer having high strength and high water repellency.

The inventors conducted extensive studies in order to address the above problem, and found a microporous layer having both high strength and high water repellency, and completed the present disclosure.

Aspect examples of the present embodiment are described as follows.
(1) A microporous layer in which a falling angle of an aqueous solution containing 25 wt % of ethanol is less than 30° and a strength determined by SAICAS evaluation is more than 0.068 N.
(2) The microporous layer according to (1), containing two or more types of fluororesins having different melt viscosities.
(3) The microporous layer according to (1) or (2), containing a fluororesin and conductive particles, wherein, based on a total amount of 100 mass % of the fluororesin and the conductive particles, the amount of the fluororesin is more than 0 mass % and 40 mass % or less.
(4) The microporous layer according to any one of (1) to (3), containing a fluororesin A and a fluororesin B having a lower melt viscosity than the fluororesin A, wherein a fluororesin A/fluororesin B (mass ratio), which is a mass ratio of the fluororesin A and the fluororesin B, is 1/6 to 3/1.
(5) A method of producing a microporous layer, including firing a gas diffusion layer substrate to which a paste for forming a microporous layer containing two or more types of fluororesins is applied at a temperature 10° C. higher than a melting point of a fluororesin having a high melting point for 1 to 5 minutes.

According to the present disclosure, it is possible to provide a microporous layer having high strength and high water repellency.

### DETAILED DESCRIPTION OF EMBODIMENTS

Hereinafter, a microporous layer and a method of producing a microporous layer according to the present embodiment will be described in detail. The microporous layer of the present embodiment is a microporous layer in which a falling angle of an aqueous solution containing 25 wt % of ethanol is less than 30° and the strength determined by SAICAS evaluation is more than 0.068 N.

### (Microporous Layer)

The microporous layer (hereinafter referred to as MPL) is generally formed on the surface of a gas diffusion layer substrate, and the microporous layer and the gas diffusion layer substrate constitute the gas diffusion layer. The gas diffusion layer is generally used as one of members constituting a solid polymer fuel cell. In the solid polymer fuel cell, the microporous layer is a layer formed on the surface of the gas diffusion layer substrate on the side of the catalyst layer, and is a member provided to facilitate discharge of water purified in the catalyst layer. The MPL generally contains conductive particles and a water-repellent resin. Examples of water-repellent resins of the present embodiment include a fluororesin, and it is preferable to use two or more types of fluororesins having different melt viscosities.

Examples of fluororesins include polytetrafluoroethylene (PTFE), tetrafluoroethylene-perfluoroalkyl vinyl ether copolymer (PFA), tetrafluoroethylene-hexafluoropropylene copolymer (FEP), polychlorotrifluoroethylene (PCTFE), ethylene-tetrafluoroethylene copolymer (ETFE), polyvinylidene fluoride (PVDF), and polyhexafluoropropylene. As the fluororesin, two or more types of fluororesins having different melt viscosities are used in a certain embodiment, and two types of fluororesins having different melt viscosities are used in another aspect.

In one preferable aspect, the MPL contains a fluororesin A and a fluororesin B having a lower melt viscosity than the fluororesin A. The fluororesin A is a resin having a higher melt viscosity than the fluororesin B, and the fluororesin B is a resin having a lower melt viscosity than the fluororesin A. That is, the fluororesin A and the fluororesin B are relative concepts determined by comparing the melt viscosities of two types of fluororesins. Here, in the present disclosure, the melt viscosity is a melt viscosity at a temperature 50° C. higher than the melting point of each fluororesin. The melt viscosity of the fluororesin may be determined from various literature, measured in-house, or found in a product catalog and the like.

Examples of combinations of the fluororesin A and the fluororesin B include a combination in which the fluororesin A is PTFE, and the fluororesin B is PFA, FEP, PCTFE, or ETFE. Specific examples include a combination in which the fluororesin A is PTFE and the fluororesin B is PFA, and a combination in which the fluororesin A is PTFE, and the fluororesin B is FEP. In the MPL, at least some of the fluororesin A having a high melt viscosity may be present in the MPL in the form of an aggregation, and when the fluororesin A is present in the MPL in the form of an aggregation, the size of the aggregation is preferably 10 μm or less. On the other hand, the fluororesin B having a low melt viscosity preferably coats the surface of conductive particles. The difference in melt viscosity between the fluororesin A and the fluororesin B is not particularly limited, and is 10⁵ to 10⁷ P (poise) in one preferable aspect.

The fluororesin A/fluororesin B (mass ratio), which is a mass ratio of the fluororesin A and the fluororesin B, is not particularly limited, and is, for example, 1/6 to 3/1, preferably 1/5 to 1/1, and more preferably 1/4 to 3/4.

As the amount of the fluororesin, based on a total amount of 100 mass % of the fluororesin and the conductive particles, the amount of the fluororesin is more than 0 mass %, preferably 40 mass % or less, more preferably 10 to 40 mass %, and particularly preferably 20 to 40 mass %.

When the fluororesin A and the fluororesin B are used as the fluororesin, it is preferable that the amount of the fluororesin A be 3 to 25 mass % and the amount of the fluororesin B be 7 to 25 mass %, it is more preferable that the amount of the fluororesin A be 5 to 20 mass % and the amount of the fluororesin B be 10 to 25 mass %, and it is still more preferable that the amount of the fluororesin A be 5 to 15 mass % and the amount of the fluororesin B be 15 to 25 mass %.

The conductive particles are not limited as long as they are substances having conductivity, and examples thereof include carbon materials, tin oxide, precious metals, titanium nitride, and mixtures thereof. As the conductive particles, carbon materials and titanium nitride are preferable. Examples of carbon materials include carbon black, carbon fibers, carbon nanotubes, carbon nanohorns, graphite, and activated carbon. The conductive particles are carbon particles in one preferable aspect, and more preferably carbon particles having an average particle size of 20 to 150 nm. As the conductive particles, for example, it is preferable to use carbon black having excellent conductivity and a large specific surface area, and acetylene black having high conductivity is more preferable.

The thickness of the MPL is generally more than 10 μm, preferably 15 μm or more, and more preferably 20 μm or more. If the thickness of the MPL becomes too thick, the gas diffusion resistance increases, and the output of the fuel cell may decrease. Therefore, the thickness of the MPL is preferably 60 μm or less, more preferably 50 μm or less, and still more preferably 40 μm or less.

In the MPL, since a falling angle of an aqueous solution containing 25 wt % of ethanol is less than 30°, the MPL has excellent water repellency. The falling angle is preferably less than 25° and more preferably less than 20°. The lower limit of the falling angle is not particularly limited, and is generally 4° or more. The falling angle can be measured by the method described in examples.

Since the MPL has a strength of more than 0.068 N determined by SAICAS evaluation, the MPL has excellent strength. The strength determined by SAICAS evaluation is preferably more than 0.08 N, and more preferably more than 0.1 N. The upper limit of the strength determined by SAICAS evaluation is not particularly limited, and is generally 0.3 N or less. The strength determined by SAICAS evaluation can be measured by the method described in examples.

### (Method of Producing Microporous Layer)

The MPL can be obtained by, for example, applying a paste for forming a microporous layer to a gas diffusion layer substrate and performing firing. Examples of MPL production methods include a method of producing a microporous layer in which a gas diffusion layer substrate to which a paste for forming a microporous layer containing two or more types of fluororesins is applied is fired at a temperature 10° C. higher than the melting point of the fluororesin having a high melting point for 1 to 5 minutes.

The paste for forming a microporous layer generally contains conductive particles such as the above carbon material and a water-repellent resin such as a fluororesin. The paste for forming a microporous layer generally contains a dispersion medium in consideration of coatability, and preferably contains a dispersant in order to uniformly disperse conductive particles and a water-repellent resin.

Examples of dispersion media include water, an organic solvent, and a mixed solvent of water and an organic solvent, and water is preferable in consideration of an environmental load. The dispersant is not particularly limited, and includes, for example, surfactants, specifically, nonionic surfactants, cationic surfactants, and anionic surfactants. When a dispersant is included in the paste for forming a microporous layer, at least some of the dispersant and its fired product may be included in the MPL.

The amounts of the dispersion medium and the dispersant are not particularly limited, and can be appropriately set in consideration of coatability of the paste for forming a microporous layer and in order to uniformly disperse conductive particles and a water-repellent resin. For example, the dispersant can be used in a solid content proportion of 3 to 20 mass %, and preferably 5 to 15 mass % with respect to conductive particles.

Examples of methods of preparing a paste for forming a microporous layer include a method of mixing and kneading components until the components become uniform.

The gas diffusion layer substrate is not particularly limited, and porous carbon components such as carbon paper and carbon cloth can be used.

The method of applying a paste for forming a microporous layer to a gas diffusion layer substrate is not particularly limited, and it can be performed using, for example, a die coating machine.

When the paste for forming a microporous layer contains two or more types of fluororesins, firing is generally performed at a temperature 10° C. higher than the melting point of the fluororesin having a high melting point. Here, when two types of fluororesins are used, the fluororesin having a high melting point is a fluororesin having a higher melting point, and when three or more types of fluororesins are used, the fluororesin having a high melting point is the fluororesin having the highest melting point. Firing is performed preferably at 330° C. or higher, more preferably at 340° C. or higher, and still more preferably at 345° C. or higher. The firing time is generally 1 to 5 minutes, and preferably 2 minutes to 4 minutes and 40 seconds, or 3 minutes to 4 minutes and 20 seconds.

Firing is generally performed in a firing furnace, and as the firing furnace, for example, a batch furnace or a continuous furnace can be used.

Hereinafter, the present embodiment will be described with reference to examples, but the present disclosure is not limited thereto.

### Examples and Comparative Examples

A gas diffusion layer with a microporous layer was produced through the following Processes 1 to 4.

As the fluororesin A having a high melt viscosity, polytetrafluoroethylene (PTFE) (PTFE dispersion (product number: AD911E) commercially available from AGC) was used.

As the fluororesin B having a low melt viscosity, a tetrafluoroethylene-perfluoroalkyl vinyl ether copolymer (PFA) (PFA dispersion (product number: AD-2CRER) commercially available from Daikin Industries, Ltd.) was used.

Carbon particles having a particle size of 20 to 150 nm, having conductivity suitable for use in fuel cells, and having reduced metal contamination were used.

Examples and comparative examples were performed in the same method except that the type of the fluororesin and the proportions with respect to carbon in Process 1 were different, and the temperature and the time in Process 4 were different.

In Comparative Example 1, firing in Process 4 was performed at 150° C., which is a temperature 10° C. lower than the melting point)(327° C. of the fluororesin A (PTFE). In other examples and comparative examples, firing was performed at a temperature of 317° C. or higher.

In addition, in Comparative Examples 1 to 8, an MPL was prepared suing the fluororesin A alone or the fluororesin B alone as the fluororesin.

### [Process 1]

Carbon as conductive particles, a fluororesin, a dispersant, and deionized water were prepared and mixed to obtain a mixture.

In examples and comparative examples, through Process 1 and Process 2 to be described below, a paste for forming a microporous layer (paste for forming MPL) was produced. The paste for forming a microporous layer was prepared so that, based on a total amount of 100 mass % of the fluororesin and the conductive particles (carbon), the amount of carbon was 60 to 90 mass %, the amount of the fluororesin was 10 to 40 mass %, and the solid content proportion of the dispersant with respect to carbon was 5 to 15 mass %.

### [Process 2]

The mixture obtained in Process 1 was kneaded using a stirrer to obtain a paste for forming MPL. That is, the mixture obtained in Process 1 was kneaded so that respective materials were uniformly dispersed.

### [Process 3]

The paste for forming MPL obtained in Process 2 was applied onto a gas diffusion layer substrate using a die coating machine. Carbon paper, which is a porous component, was used as the gas diffusion layer substrate.

### [Process 4]

The gas diffusion layer substrate to which the paste for forming MPL was applied in Process 3 was dried and fired to produce a gas diffusion layer with a microporous layer that can be used in fuel cells.

The following Table 1 shows fluororesins, the amount (mass %) of the fluororesin A and the amount (mass %) of the fluororesin B based on a total amount of 100 mass % of the fluororesin and carbon, and the firing temperature (° C.) and the firing time in Process 4 in examples and comparative examples.

TABLE 1

| | Amount of | Amount of | Firing | |
|---|---|---|---|---|
| | fluororesin A | fluororesin B | temperature | Firing |
| | (mass %) | (mass %) | (° C.) | time |
| Comparative | 15 | 0 | 150 | 2 min and 15 |
| Example 1 | | | | sec |
| Comparative | 15 | 0 | 320 | 2 min and 15 |
| Example 2 | | | | sec |
| Comparative | 20 | 0 | 356 | 2 min and 15 |
| Example 3 | | | | sec |
| Comparative | 30 | 0 | 356 | 2 min and 15 |
| Example 4 | | | | sec |
| Comparative | 40 | 0 | 356 | 2 min and 15 |
| Example 5 | | | | sec |
| Comparative | 0 | 10 | 356 | 2 min and 15 |
| Example 6 | | | | sec |
| Comparative | 0 | 20 | 350 | 4 min |
| Example 7 | | | | |
| Comparative | 0 | 40 | 356 | 2 min and 15 |
| Example 8 | | | | sec |
| Example 1 | 15 | 20 | 350 | 4 min |
| Example 2 | 15 | 10 | 350 | 4 min |
| Example 3 | 20 | 20 | 350 | 4 min |
| Example 4 | 20 | 10 | 350 | 4 min |
| Example 5 | 10 | 20 | 350 | 4 min |
| Example 6 | 5 | 20 | 350 | 4 min |

### (Falling Angle)

In the gas diffusion layers with a microporous layer obtained in examples and comparative examples, the microporous layer was subjected to water repellency evaluation, and the falling angle was determined.

A falling angle measuring device was used. Droplets of 25 μl of an aqueous solution containing 25 wt % of ethanol were added dropwise onto the surface of the microporous layer, the minimum tilt angle at which droplets fell was determined and defined as the falling angle. The falling angle is shown in Table 2.

### (SAICAS Evaluation)

In the gas diffusion layers with a microporous layer obtained in examples and comparative examples, the microporous layer was subjected to SAICAS evaluation.

According to Japanese Unexamined Patent Application Publication No. 2021-118181 (JP 2021-118181 A) and the SAICAS method principle diagram cited in the publication (cited from http://www.wintes.co.jp/genrizusaicas.html), the average horizontal resistance force (N) measured under the following conditions was defined as the strength of the microporous layer determined by SAICAS evaluation.

The cutting blade used had a blade width of 1 mm, a rake angle of 20 degrees, a blade of 60 degrees, and a clearance angle of 10 degrees. Using the cutting blade, the horizontal resistance force and the vertical resistance force were applied onto the surface of the microporous layer. When the cutting blade was pressed against the microporous layer, the cutting blade moved biaxially, and the microporous layer was cut by the cutting blade (cutting stage). In addition, after the cutting blade reached a depth of 10 μm, the movement of the cutting blade changed from biaxial movement to uniaxial movement (constant to a depth of 10 μm), an average value of the horizontal resistance force for 150 seconds was acquired, and the average value was defined as the average horizontal resistance force (N). Table 2 shows the average horizontal resistance force (N).

### (Power Generation Evaluation)

Both sides of an integrated product of an electrolyte membrane and a catalyst layer were inserted using the gas diffusion layers with a microporous layer obtained in examples and comparative examples so that the catalyst layer and the microporous layer were in contact with each other to prepare a membrane electrode assembly. The obtained membrane electrode assembly was assembled into a single cell for a fuel cell to produce a fuel cell. Power generation evaluation (power generation performance test) was performed under the following conditions. A cell in which the single cell had a groove/rib width of 0.4/0.2 mm and about 3 μm of the surface was treated with gold plating or the like was used.

### [Power Generation Performance Test Under Excessively High Humidity (RH 165%) Condition]

The obtained fuel cell was used to generate power under the following conditions.
anode gas: hydrogen gas with a relative humidity (RH) of 165% (a dew point of 55° C.)
cathode gas: air with a relative humidity (RH) of 165% (a dew point of 55° C.)
cell temperature (cooling water temperature): 45° C.

A current density I-voltage V curve was obtained by power generation. Table 2 shows the cell voltage (V) of 3.0 A/cm² in the obtained I-V curve.

### [Power Generation Performance Test Under High Humidity (RH 80%) Condition]

The obtained fuel cell was used to generate power under the following conditions.
anode gas: hydrogen gas with a relative humidity (RH) of 80% (a dew point of 55° C.)
cathode gas: air with a relative humidity (RH) of 80% (a dew point of 55° C.)
cell temperature (cooling water temperature): 60° C.

A current density I-voltage V curve was obtained by power generation. Table 2 shows the cell voltage (V) of 4.0 A/cm² in the obtained I-V curve.

TABLE 2

| | | Average | Cell voltage | Cell voltage |
|---|---|---|---|---|
| | Falling | horizontal | [3.0 | [4.0 |
| | angle | resistance force | A/cm², | A/cm², |
| | (°) | (N) | 165% RH] (V) | 80% RH] (V) |
| Comparative | | 0.022 | | |
| Example 1 | | | | |
| Comparative | | 0.082 | | |
| Example 2 | | | | |
| Comparative | | 0.107 | 0.068 | 0.272 |
| Example 3 | | | | |
| Comparative | 37 | 0.162 | | |
| Example 4 | | | | |
| Comparative | 58 | 0.262 | 0.493 | 0.459 |
| Example 5 | | | | |
| Comparative | 4 | 0.023 | 0.519 | 0.459 |
| Example 6 | | | | |
| Comparative | 10 | 0.049 | 0.558 | 0.494 |
| Example 7 | | | | |
| Comparative | | 0.068 | 0.529 | 0.539 |
| Example 8 | | | | |
| Example 1 | 15 | 0.190 | 0.569 | 0.520 |
| Example 2 | 17 | 0.180 | 0.514 | 0.490 |
| Example 3 | 17 | 0.200 | 0.570 | 0.519 |
| Example 4 | 12 | 0.216 | 0.509 | 0.460 |
| Example 5 | 7 | 0.186 | | |
| Example 6 | 8 | 0.135 | | |

If the falling angle was less than 30°, it was evaluated as having excellent water repellency, and if the average horizontal resistance force was more than 0.068 N, it was evaluated as having excellent strength. In addition, if the cell voltage [3.0 A/cm², 165% RH] was more than 0.493 V and the cell voltage [4.0 A/cm², 80% RH] was more than 0.459 V, it was evaluated as having excellent power generation performance.

In Comparative Example 1, only PTFE was used as the fluororesin, and firing was performed at a temperature equal to or lower than the melting point of PTFE. In the obtained gas diffusion layer with a microporous layer, the strength of the microporous layer was low. This is thought to be caused by the fact that, since firing was performed at a low temperature, PTFE did not melt and spread during firing, and an effect of binding carbon particles was insufficient.

In Comparative Examples 2 to 5, only PTFE was used as the fluororesin, and firing was performed at a temperature similar to that of examples. In the obtained gas diffusion layer with a microporous layer, the water repellency and power generation performance of the microporous layer were poor.

In Comparative Examples 6 to 8, only PFA was used as the fluororesin, and firing was performed at a temperature similar to that of examples. In the obtained gas diffusion layer with a microporous layer, the strength of the microporous layer was poor.

The inventors speculated that the results of Comparative Examples 2 to 8 were due to the difference in the direction in which the fluororesin melted and spread during firing. That is, it is thought that PTFE did not easily melt and spread and remained in a submicron size in the microporous layer, which bonded carbon particles to each other, and resulted in high strength, but it could not coat some carbon particles, which resulted in low water repellency and low power generation performance. On the other hand, it is thought that PFA easily melted and spread, and did not remain in a submicron size in the microporous layer, and it was difficult to bind carbon particles to each other, which resulted in poor strength, but carbon could be sufficiently coated, and it tended to exhibit high water repellency and high power generation performance.

In examples, when two types of fluororesins were used, a microporous layer capable of realizing excellent strength, water repellency, and power generation performance was obtained.

The upper limit value and/or the lower limit value of the numerical value range described in this specification could be arbitrarily combined to define a preferable range. For example, the upper limit value and the lower limit value of the numerical value range could be arbitrarily combined to define a preferable range, the upper limit values of the numerical value range could be arbitrarily combined to define a preferable range, and the lower limit values of the numerical value range could be arbitrarily combined to define a preferable range.

While the present embodiment has been described above in detail, specific configurations are not limited to the embodiment, and design modifications without departing from the scope of the present disclosure may be included in the present disclosure.

What is claimed is:

1. A microporous layer in which a falling angle of an aqueous solution containing 25 wt % of ethanol is less than 30° and a strength determined by SAICAS evaluation is more than 0.068 N.

2. The microporous layer according to claim 1, comprising two or more types of fluororesins having different melt viscosities.

3. The microporous layer according to claim 1, comprising a fluororesin and conductive particles,
wherein, based on a total amount of 100 mass % of the fluororesin and the conductive particles, the amount of the fluororesin is more than 0 mass % and 40 mass % or less.

4. The microporous layer according to claim 1, comprising a fluororesin A and a fluororesin B having a lower melt viscosity than the fluororesin A,
wherein a fluororesin A/fluororesin B (mass ratio), which is a mass ratio of the fluororesin A and the fluororesin B, is 1/6 to 3/1.

5. A method of producing a microporous layer, comprising
firing a gas diffusion layer substrate to which a paste for forming a microporous layer containing two or more types of fluororesins is applied at a temperature 10° C. higher than a melting point of a fluororesin having a high melting point for 1 to 5 minutes.
